(19) United States
(12) Patent Application Publication
(10) Pub. No.: US 2026/0292937 A1
(43) Pub. Date: Sep. 24, 2026

(54) INFRARED HEATING SYSTEM FOR HVAC&R SYSTEM

(71) Applicant: Tyco Fire & Security GmbH, Neuhausen am Rheinfall (CH)

(72) Inventors: Sandip Maruti Chitale, Pune (IN); Sagar Ramesh Giri, Samsherpur (IN); Shivchandra Venkatrao Nagime, Latur (IN); Heather Callaghan, Dover, PA (US); Robert Allen Amick, York, PA (US)

(21) Appl. No.: 19/577,267

(22) Filed: Mar. 24, 2026

Related U.S. Application Data
(60) Provisional application No. 63/776,797, filed on Mar. 24, 2025.

(51) Int. Cl. H05B 3/02; F28F 3/02

(52) U.S. Cl. CPC H05B 3/02; F28F 3/02; F28F 2215/00; H05B 2203/022; H05B 2203/032

(57) ABSTRACT

A heater assembly for a heating, ventilation, air conditioning, and refrigeration (HVAC&R) system includes a frame having a first panel, a second panel, a third panel, and a fourth panel cooperatively defining an air flow inlet, an air flow outlet, and an air flow path extending through the frame from the air flow inlet to the air flow outlet. The heater assembly also includes a first fin assembly disposed within the frame at the air flow inlet and a second fin assembly disposed within the frame at the air flow outlet. The heater assembly further includes a plurality of infrared emitters disposed within the frame, extending across the air flow path, and extending between the first panel and the second panel, where the plurality of infrared emitters is configured to heat an air flow directed through the frame and along the air flow path, and where the plurality of infrared emitters is configured to heat the first fin assembly, the second fin assembly, or both

### CROSS-REFERENCE TO RELATED APPLICATIONS

This application claims priority from and the benefit of U.S. Provisional Application No. 63/776,797, entitled “INFRARED HEATING SYSTEM FOR HVAC SYSTEM,” filed Mar. 24, 2025, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, air conditioning, and refrigeration (HVAC&R) systems, such as chiller systems and/or other vapor compression systems, utilize a working fluid (e.g., refrigerant) that changes phases between vapor, liquid, and combinations thereof in response to exposure to different temperatures and pressures within components of the HVAC&R system. Certain HVAC&R systems, such as an air handling unit (AHU), may include devices configured to ventilate one or more air flows and/or control a temperature of the one or more air flows that are delivered to the conditioning equipment and/or a conditioned environment serviced by the HVAC&R system. For example, the HVAC&R system may receive one or more air flows (e.g., ambient air flow, return air flow) and direct the one or more air flows through an AHU before the one or more air flows are directed to a space to be conditioned. In some systems, the AHU may include a heat exchanger configured to condition the one or more air flows before the one or more air flows directed are to the space to be conditioned. The heat exchanger may be implemented to cool the one or more air flows or heat the oven or more air flows, in some instances. Unfortunately, many heat exchangers, such as heaters, may be inefficient, heavy, complicated and/or unduly large.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heater assembly for a heating, ventilation, air conditioning, and refrigeration (HVAC&R) system includes a frame having a first panel, a second panel, a third panel, and a fourth panel cooperatively defining an air flow inlet, an air flow outlet, and an air flow path extending through the frame from the air flow inlet to the air flow outlet. The heater assembly also includes a first fin assembly disposed within the frame at the air flow inlet and a second fin assembly disposed within the frame at the air flow outlet. The heater assembly further includes a plurality of infrared emitters disposed within the frame, extending across the air flow path, and extending between the first panel and the second panel, where the plurality of infrared emitters is configured to heat an air flow directed through the frame and along the air flow path, and where the plurality of infrared emitters is configured to heat the first fin assembly, the second fin assembly, or both.

In another embodiment, a heating, ventilation, air conditioning, and refrigeration (HVAC&R) system includes an air handling unit having a housing configured to receive and direct an air flow therethrough, a mounting wall disposed within the housing of the air handling unit, where the mounting wall has an aperture, and an infrared heater assembly mounted to the mounting wall. The infrared heater assembly includes a frame defining an air flow path extending through the frame and configured to direct the air flow through the frame, where the air flow path is aligned with the aperture of the mounting wall relative to a direction of the air flow through the housing, and a plurality of infrared emitters coupled to the frame and disposed within the air flow path, where the plurality of infrared emitters is configured to heat the air flow directed through the frame. The HVAC&R system further includes a controller communicatively coupled to the plurality of infrared emitters and configured to operate the plurality of infrared emitters to heat the air flow, where the controller is physically separate from the infrared heater assembly.

In a further embodiment, an infrared heater assembly includes a frame having a plurality of panels coupled to one another, where the plurality of panels defines an air flow path extending through the frame from an air flow inlet of the frame to an air flow outlet of the frame. The infrared heater assembly also includes a first fin assembly coupled to the frame and disposed within the air flow path, where the first fin assembly has a first plurality of fins, and a second fin assembly coupled to the frame and disposed within the air flow path, where the second fin assembly has a second plurality of fins. The infrared heater assembly further includes a plurality of infrared emitters coupled to the frame and positioned between the first fin assembly and the second fin assembly, relative to a direction of an air flow through the frame and along the air flow path, where the plurality of infrared emitters is configured to heat the air flow, the first plurality of fins, and the second plurality of fins.

### BRIEF DESCRIPTION OF THE DRAWINGS

Various aspects of this disclosure may be better understood upon reading the following detailed description and upon reference to the drawings in which:

FIG. 1 is a perspective view of a building including an embodiment of a heating, ventilating, air conditioning, and/or refrigeration (HVAC&R) system, in accordance with an aspect of the present disclosure;

FIG. 2 is a block diagram of an embodiment of an airside system including an air handling unit (AHU) that may be used in an HVAC&R system, in accordance with an aspect of the present disclosure;

FIG. 3 is a cutaway perspective view of an embodiment of an infrared heater assembly of an HVAC&R system, in accordance with an aspect of the present disclosure;

FIG. 4 is a cross-sectional plan view of an embodiment of an infrared heater assembly of an HVAC&R system, in accordance with an aspect of the present disclosure; and

FIG. 5 is cutaway perspective view schematic of an embodiment of an AHU including an embodiment of an infrared heater, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terminals “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

In accordance with the present disclosure, a heating, ventilating, air conditioning, and/or refrigeration (HVAC&R) system, such as an air handling unit (AHU), may include an infrared heater assembly configured to heat an air flow directed through the AHU via one or more infrared emitters (e.g., a plurality of infrared emitters, infrared emitting tubes, short wave emitters) and a plurality of fins (e.g., heat transfer fins). The infrared heater assembly may include a frame (e.g., housing, casing) defined by one or more panels (e.g., sides) and configured to support the one or more infrared emitters. Further, the infrared heater assembly may include a first heat transfer assembly (e.g., first fin assembly, first finned side, upstream side, first louvered side) and a second heat transfer assembly (e.g., second fin assembly, second finned side, downstream side, second louvered side). Each of the first and second heat transfer assemblies may include a plurality of fins that enables improved heating (e.g., more uniform heating) of the air flow. The infrared heater assembly may have a reduced weight and/or a reduced overall physical footprint, relative to other heater assemblies, which may enable placement of the infrared heater assemblies in and/or on areas (e.g., AHU walls, duct walls) that may not be able to secure and/or support relatively heavy objects (e.g., other types of heaters). Additionally, the reduced size of the infrared heater assembly may enable a reduction in obstruction along an air flow path through the AHU, compared to other heater configurations, which may reduce a pressure drop of the air flow across the infrared heater assembly.

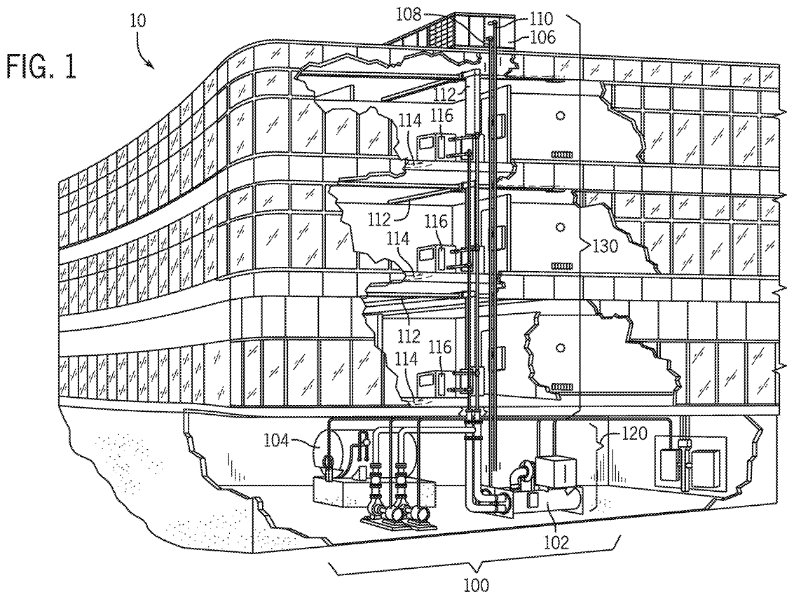

Turning now to the drawings, FIG. 1 is a perspective view of an embodiment of a heating, ventilating, air conditioning, and/or refrigeration (HVAC&R) system 100 for a building 10 that may employ one or more HVAC&R units (e.g., air handling units) configured to provide heating, cooling, air conditioning, ventilation, and/or other conditioning for an air flow directed into the building 10. For example, the HVAC&R system 100 is shown to include a water side system 120 and an air side system 130. The water side system 120 may provide a heated fluid and/or a chilled fluid to an air handling unit of the air side system 130. In an embodiment, the air side system 130 may use the heated fluid and/or chilled fluid to heat and/or cool an air flow provided to the building 10.

As illustrated in FIG. 1, the HVAC&R system 100 includes a chiller 102, a boiler 104, and an air handling unit (AHU) 106. The water side system 120 may operate the chiller 102 or the boiler 104 to cool or heat a heat transfer fluid (e.g., water, glycol, etc.) and may circulate the heat transfer fluid to the AHU 106. In some embodiments, the HVAC&R devices of the water side system 120 can be located in or around the building 10, as shown in FIG. 1, or at an offsite location, such as a central plant (e.g., chiller plant, steam plant, heat plant, etc.), that serves one or more buildings including the building 10. The heat transfer fluid can be cooled in the chiller 102 or heated in the boiler 104, depending on whether heating or cooling is desired in the building 10. The chiller 102 may place the circulated heat transfer fluid in a heat exchange relationship with another fluid (e.g., working fluid, refrigerant) in a heat exchanger (e.g., evaporator) to absorb heat from the circulated heat transfer fluid. The boiler 104 may add heat to the circulated heat transfer via any suitable technique, such as an electric heating element. The heat transfer fluid from the chiller 102 and/or the boiler 104 may be transported to the AHU 106 via piping 108.

The AHU 106 may place the heat transfer fluid in a heat exchange relationship with an air flow directed through the AHU 106 (e.g., via one or more stages of cooling and/or heating coils). The air flow can be, for example, outside air, return air from within the building 10, or a combination of both. The AHU 106 may transfer heat between the air flow and the heat transfer fluid to provide heating or cooling for the air flow. For example, the AHU 106 can include one or more fans or blowers configured to direct the air flow over or through a heat exchanger containing the heat transfer fluid. The heat transfer fluid may then return to the chiller 102 or the boiler 104 via piping 110. In some embodiments, the fans or blowers may be configured to direct the air flow over or across one or more infrared heater assemblies in addition to or alternative to the heat exchanger. In some embodiments, the infrared heater assemblies may be positioned upstream of the heat exchangers, relative to a flow direction of air flow, and are configured to heat the air flow prior to entering the heat exchange relationship with the heat transfer fluid in the heat exchanger.

The air side system 130 may deliver the air flow supplied by the AHU 106 (e.g., supply air flow) to the building 10 via supply air ducts 112 and may provide return air from the building 10 to the AHU 106 via return air ducts 114. In some embodiments, the air side system 130 may include multiple variable air volume (VAV) units 116. For example, the air side system 130 is shown to include separate VAV units 116 on each floor or zone of the building 10. The VAV units 116 can include dampers or other flow control elements that can be operated to control an amount of the supply air flow provided to individual zones of the building 10. In other embodiments, the air side system 130 delivers the supply air flow into one or more zones of the building 10 (e.g., via the supply air ducts 112) without using intermediate VAV units 116 or other flow control elements. In some embodiments, the VAV units 116 may control additional heating elements separate than those of the AHU 106. The AHU 106 can include various sensors (e.g., temperature sensors, pressure sensors, humidity sensors, etc.) configured to measure attributes of the supply air flow. The AHU 106 may receive input from sensors located within the AHU 106 and/or within the building zone and may adjust the flow rate, temperature, or other attributes of the supply air flow through the AHU 106 to achieve setpoint conditions for the building zone.

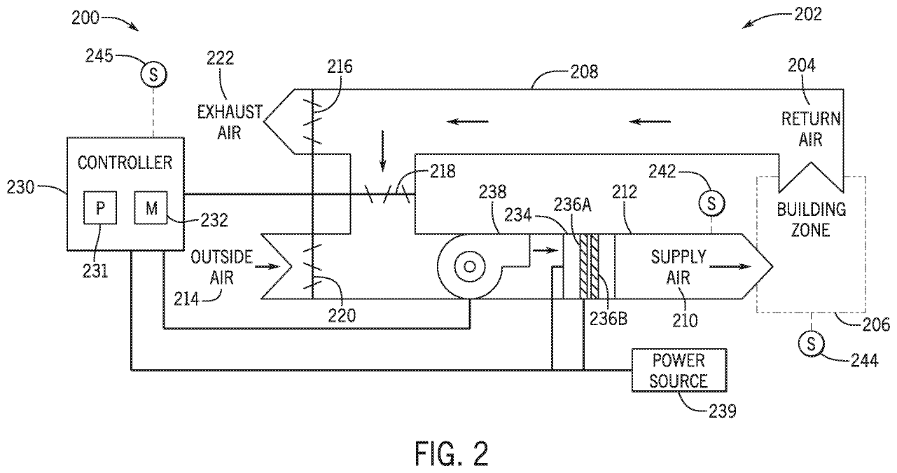

Referring now to FIG. 2, a block diagram of an embodiment of an air side system 200 (e.g., AHU) is illustrated. In some embodiments, the air side system 200 may supplement or replace the air side system 130 in the HVAC&R system 100 of FIG. 1 or can be implemented separate from the HVAC&R system 100. When implemented in the HVAC&R system 100, the air side system 200 may include a number of the HVAC&R devices in the HVAC&R system 100 (e.g., AHU 106, VAV units 116, ducts 112-114, fans, dampers, etc.) and can be located in or around the building 10 of FIG. 1. The air side system 200 may operate to heat an air flow provided to the building 10 using one or more infrared heater assemblies, in accordance with the present techniques.

As illustrated in FIG. 2, the air side system 200 may include an air handling unit (AHU) 202, such as an economizer-type AHU. Economizer-type AHUs vary the amount of outside air and return air used by the AHU 202 for heating or cooling. For example, the AHU 202 may receive return air 204 from a building zone 206 via a return air duct 208 and may deliver supply air 210 to the building zone 206 via a supply air duct 212. In some embodiments, the AHU 202 is a rooftop unit located on the roof of the building 10 (e.g., AHU 106 of FIG. 1) or otherwise positioned to receive both the return air 204 and outside air 214. The AHU 202 may be configured to operate an exhaust air damper 216, a mixing damper 218, and an outside air damper 220 to control an amount of the outside air 214 and the return air 204 that combine to form the supply air 210. Any return air 204 that does not pass through the mixing damper 218 may be exhausted from the AHU 202 through the exhaust damper 216 as exhaust air 222. The exhaust air damper 216, the mixing damper 218, and the outside air damper 220 may be controlled by a controller 230 and operated by one or more actuators. As will be appreciated, embodiment of the infrared heater assembly disclosed herein may be implemented with any suitable type of AHU and may also be implemented in any HVAC&R system configured to heat an air flow. As will be made clear below, the simplified, lightweight design and the mounting capabilities of the disclosed infrared heater assembly embodiments may be implemented in various ducts and/or AHUs and may be manufactured to accommodate systems of varying sizes, capacities, air flow rates, load demands, and so forth.

Still referring to FIG. 2, the AHU 202 includes an infrared heater assembly 234 and a fan 238 positioned within the supply air duct 212. The fan 238 is configured to force (e.g., direct) the supply air 210 across one or more infrared emitters 236 of the infrared heater assembly 234 (e.g., infrared heater, infrared heating system, modular infrared heater assembly) and provide the supply air 210 to the building zone 206. The controller 230 may communicate with the fan 238 to control a flow rate of the supply air 210. In some embodiments, the controller 230 is configured to control an amount of heating applied to the supply air 210 by modulating a speed of the fan 238 and/or via control of the infrared emitters 236 of the infrared heater assembly 234.

The infrared emitters 236 of the infrared heater assembly 234 may be electrically connected to a power source 239 and communicatively connected to the controller 230. The controller 230, components thereof, the power source 239, and/or additional electrical components associated with the infrared heater assembly 234 may be positioned or disposed away from (e.g., offboard, physically separate from) the infrared heater assembly 234 and structural components thereof (e.g., a frame). In this way, the infrared heater assembly 234 (e.g., a frame of the infrared heater assembly 234 and the infrared emitters 236, a configuration of the infrared heater assembly 234) may have a reduced weight and/or a reduced overall physical footprint (e.g., a reduced size), such as compared to other heater configurations that include an onboard or physically connected power source and/or controller. As a result, embodiments of the infrared heater assembly 234 disclosed herein may be configured for implementation in a wider variety of systems and system configurations. For example, the present techniques may enable placement of the infrared heater assembly 234 in and/or on areas that may not be able to secure relatively heavy objects (e.g., other heater configurations, such as gas heaters, electric heater elements). Additionally, a reduced size of the infrared heater assembly 234 may enable reduced obstruction of air flow along an air flow path, such as compared to other heater designs and configurations, which may enable a reduction in a pressure drop of an air flow directed through the infrared heater assembly 234.

To electrically and/or communicatively couple the controller 230 and/or the power source 239 to the infrared heater assembly 234, one or more wires or cables may extend to the infrared emitters 236, such as along a frame of the infrared heater assembly 234, along ductwork, along the AHU 202, and/or along other components. Indeed, by implementing the one or more wires, the infrared heater assembly 234 may be electrically coupled to one or more electrical components (e.g., controller 230, power source 239), yet such components may be physically separated and/or remote from the infrared heater assembly 234 (e.g., positioned external to and/or away from the AHU 202). Thus, an overall weight of the infrared heater assembly 234 may be reduced, which may enable or facilitate improved manufacturing and/or installation. For example, embodiment of the infrared heater assembly 234 disclosed herein may be more readily manufactured via an assembly line process due to the relatively smaller weight, such as compared to other heater configurations. Additionally, present embodiment of the infrared heater assembly 234 may be installed, removed, and/or replaced with greater flexibility, such as at an installed location of the AHU 202, which may facilitate improved installation, maintenance, and/or replacement procedures.

In some embodiments, the infrared emitters 236 may be independently activated, deactivated, and/or otherwise controller (e.g., by the controller 230) to modulate an amount of heating applied to the supply air 210. For example, upon receiving a first call for heating, the controller 230 may activate a first infrared emitter 236A, while suspending operation to a second infrared emitter 236B. Further, upon receiving a second call for heating, indicative of a higher temperature set point and/or greater demand for heating than the first call, the controller 230 may activate both the first infrared emitters 236A and the second infrared emitter 236B, thereby increasing heating to the supply air 210. In some embodiments, the temperature of one or more of the infrared emitters 236 may be adjusted. In an embodiment, the controller 230 may send a signal to one or more of the infrared emitters 236 to increase or decrease the temperature of the infrared emitters 236, thereby increasing or decreasing heat transfer to the supply air 210. In some embodiments, the controller 230 may increase or decrease voltage through the infrared emitters 236 to modulate heat output and heat transfer to the supply air 210. While the illustrated embodiment of the infrared heater assembly 236 includes the first infrared emitters 236A and the second infrared emitter 236B, it should be appreciated that other embodiments may include any suitable number of infrared emitters 236 (e.g., a plurality, one, three, four, five, and so forth).

Still referring to FIG. 2, the controller 230 may be configured to receive a detected temperature or other operating parameter (e.g., humidity, pressure, flow rate) from one or more sensors 242, 244, and 245 (e.g., thermocouples), which may be associated with the AHU 202. In some embodiments, the controller 230 may be configured to operate one or more components of the AHU 202 based on the detected temperature (e.g., a comparison of the detected temperature to a threshold temperature). For example, the controller 230 may receive a signal indicative of a detected temperature of the supply air 210 from the sensor 242 disposed in and/or on the supply air duct 212. The controller 230 may further operate one or more of the dampers 216, 218, and 220, the fan 238, and/or the infrared heater assembly 234 based on the detected temperature of the supply air 210. As another example, the controller 230 may receive a signal indicative of a detected temperature of air within the building zone 206 from the sensor 244 disposed in the building zone 206. The controller 230 may further operate one or more of the dampers 216, 218, and 220, the fan 238, and/or the infrared heater assembly 234 based on the detected temperature of the air within the building zone 206. Further, the controller 230 may receive a signal indicative of a detected ambient temperature (e.g., outdoor air temperature) from the sensor 245. The controller 230 may further operate one or more of the dampers 216, 218, and 220, the fan 238, and/or the infrared heater assembly 234 based on the detected ambient temperature. The discussed control configurations are non-exhaustive, and it will be appreciated that more or different control configurations and/or schemes may be utilized based on data received from the sensors 242, 243, and 245, a combination thereof, additional sensors (e.g., additional temperature sensors at different locations), alternative sensors (e.g., different types of sensors, such as pressure sensors), or any combination thereof.

The controller 230 includes processing circuitry 231, such as one or more microprocessors, which may execute software for controlling components of the AHU 202, such as the infrared heater assembly 234. The processing circuitry 231 may include multiple microprocessors, one or more “general-purpose” microprocessors, one or more special-purpose microprocessors, and/or one or more application specific integrated circuits (ASICS), or some combination thereof. For example, the processing circuitry 231 may include one or more reduced instruction set (RISC) processors.

The controller 230 may also include a memory device 232 (e.g., a memory) that may store information, such as instructions (e.g., executable instructions), control software, look up tables, configuration data, other information, or any combination thereof. The memory device 232 may include a volatile memory, such as random access memory (RAM), and/or a nonvolatile memory, such as read-only memory (ROM). The memory device 232 may store a variety of information and may be used for various purposes. For example, the memory device 232 may store processor-executable instructions including firmware or software for the processing circuitry 231 to execute, such as instructions for controlling components of the AHU 202 (e.g., HVAC&R system, infrared heater assembly 234). In some embodiments, the memory device 232 is a tangible, non-transitory, machine-readable-medium that may store machine-readable instructions for the processing circuitry 231 to execute. The memory device 232 may include ROM, flash memory, a hard drive, or any other suitable optical, magnetic, or solid-state storage medium, or a combination thereof. The memory device 232 may store data, instructions, and any other suitable data.

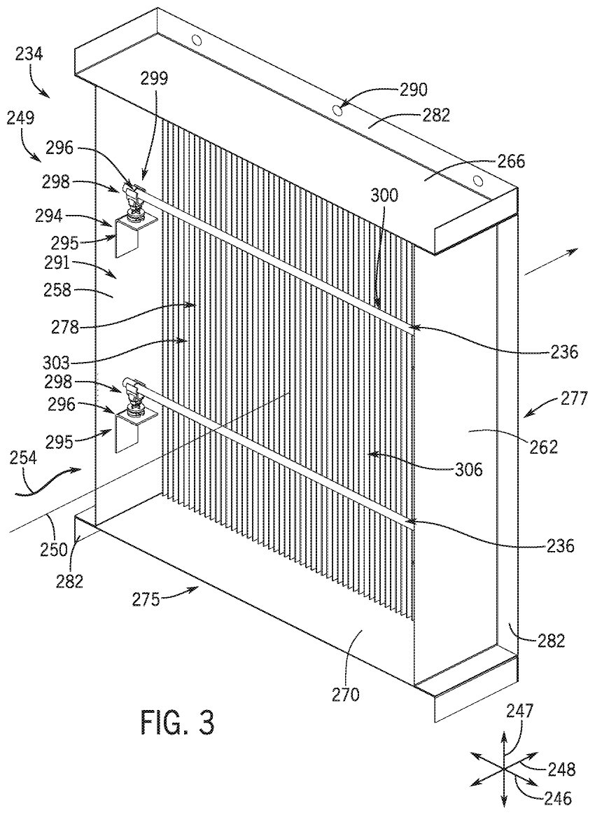

Turning now to FIG. 3, a perspective view of an embodiment of the infrared heater assembly 234 is shown, in accordance with aspects of the present disclosure. To facilitate discussion, the infrared heater assembly 234 and components thereof may be discussed with reference to an X-axis 246 (e.g., lateral axis), a Y-axis 247 (e.g., vertical axis), and a Z-axis 248 (e.g., longitudinal axis). The infrared heater assembly 234 may include a frame 249 (e.g., housing, casing) defining an air flow path 250 through which an air flow 254 may be directed (e.g., along the Z-axis 248). The frame 249 may include one or more panels (e.g., a plurality of panels) that define the air flow path 250. In the illustrated embodiment, the frame 249 includes a first panel 258 (e.g., first side, first frame piece, first lateral side panel, first stile), a second panel 262 (e.g., second side, second frame side piece, second lateral side panel, second stile), a third panel 266 (e.g., top side, top panel, third frame side piece, first rail, top rail), and a fourth panel 270 (e.g., bottom side, bottom panel, fourth frame side piece, second rail, base rail). The panels of the frame 249 are assembled to define (e.g., cooperatively define) the frame 249 and the air flow path 250 extending therethrough from an air flow inlet 275 defined by the frame 249 to an air flow outlet 277 defined by the frame 249.

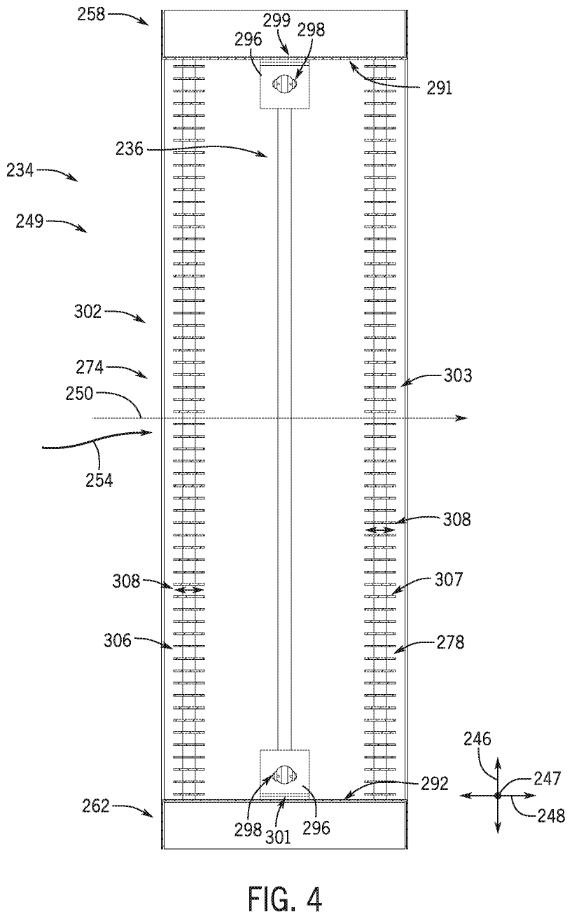

The infrared heater assembly 234 also includes a first fin assembly 274 (e.g., first heat transfer assembly, upstream assembly, first finned side, front side, air inlet, air flow inlet) disposed within the air flow path 250 and at the air flow inlet 275 of the frame 249, as shown in FIG. 4. The first fin assembly 274 is hidden in FIG. 3 for clarity. The infrared heater assembly 234 may further include a second fin assembly 278 (e.g., second heat transfer assembly, downstream assembly, second finned side, back side, air outlet, air flow outlet, downstream side) disposed within the air flow path 250 and at the air flow outlet 277 of the frame 249.

In some embodiments, the first panel 258, the second panel 262, the third panel 266, and/or the fourth panel 270 may each be a single, continuous piece, such as a single piece of sheet metal, which may be coupled or connected to one another to form the frame 249 via any suitable method, such as welding, friction fit, fasteners, and/or adhesives. In other embodiments, the frame 249 may be formed from a single piece of material, a different number of panels, and/or other components. The frame 249 may be made of or manufactured from any suitable material, such as a material resistant to heat and configured to provide structural support. Examples of materials that may be utilized to form the frame 249 include sheet metal or stainless steel (e.g., 18-gauge stainless steel). As will be appreciated, the use of infrared energy (e.g., via the infrared emitters 236) as a source of heat may enable decreased componentry (e.g., reduction of additional heating components) and a simplified support structure of the infrared heater assembly 234. For instance, components associated with gas heating may be omitted, which may enable a simplified and/or more lightweight configuration and/or support structure. As such, the infrared heater assembly 234 may include a reduced overall weight compared to other heater configurations (e.g., other electric heaters, gas heaters).

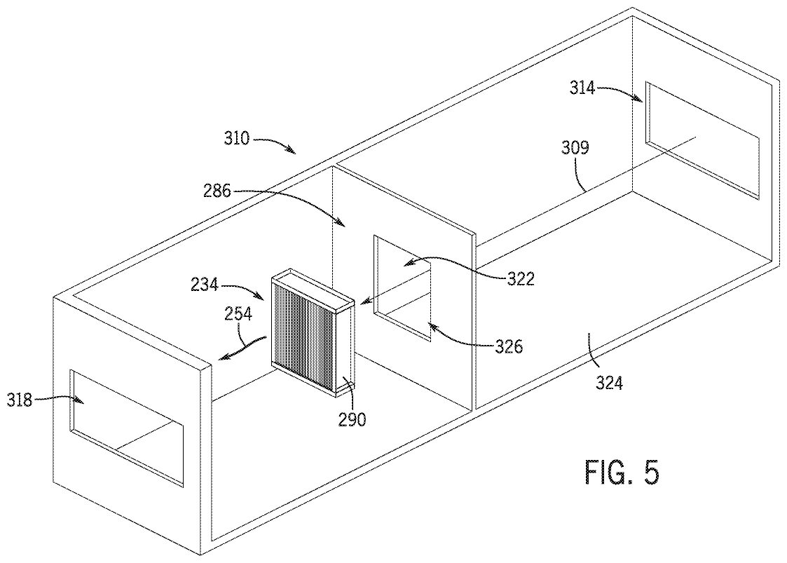

The frame 249, such as one or more of the first panel 258, the second panel 262, the third panel 266 and/or the fourth panel 270, may include one or more flanges 282 extending from a corresponding panel and configured to align (e.g., abut, contact) with a desired mounting feature and/or location (e.g., a mounting wall 286, as shown in FIG. 5). One or more flanges 282 may extend crosswise to the corresponding panel and/or may extend outward from the corresponding panel (e.g., relative to the air flow path 250), in some embodiments. For example, the frame 249 may include one or more flanges 282 extending in a direction substantially along the air flow path 250 (e.g., along the Z-axis 248) and configured to couple the frame 249 to a side or lateral wall (e.g., a first surface) of the AHU 202 or components thereof (e.g., duct, such as the supply duct 212, a housing of the AHU 202). In some embodiments, the frame 249 may include one or more flanges 282 extending substantially crosswise (e.g., perpendicular) to the air flow path 250 and configured to couple the frame 249 to the mounting wall 286 of the AHU 202 shown in FIG. 5 (e.g., a second surface). As discussed further below, the mounting wall 286 may be oriented crosswise to side walls and/or lateral walls of a housing of the AHU 202. As such, the frame 249 may couple to side or lateral wall, the mounting wall 286, or both.

In some embodiments, the flanges 282 may include one or more holes 290 (e.g., mounting holes) extending therethrough. The holes 290 may be configured to align with one or more corresponding holes (e.g., holes 326 shown in FIG. 5, mounting holes) associated with a desired mounting location of the infrared heater assembly 234. The corresponding holes (e.g., holes 326 shown in FIG. 5) may be formed in side walls and/or lateral walls of the AHU 202, in a housing of the AHU 202, in a wall of a duct, in the mounting wall 286 of the AHU 202, as shown in FIG. 5, and/or in any other suitable component to which the infrared heater assembly 234 is configured to be mounted. A corresponding fastener may extend through each hole 290 of the plurality of holes 290 and through a corresponding hole (e.g., one of the holes 326 shown in FIG. 5) to enable mounting of the infrared heater assembly 234 in an installed configuration (e.g. within the AHU 202).

As will be appreciated, due to the relatively lightweight configuration of the infrared heater assembly 234, such as compared to other heater configurations, the infrared heater assembly 234 may be mounted to one or more walls and/or surfaces, opposed to resting on a base or a floor. By mounting the infrared heater assembly 234 to a wall or surface, such as in a centralized (e.g., vertically centered and/or horizontally centered) orientation or position within the AHU 202, the air flow 254 directed through the infrared heater assembly 234 may be more uniformly heated, may flow through the infrared heater assembly 234 with more uniform distribution, may flow through the infrared heater assembly 234 with reduced flow resistance and/or turbulence, and/or may have improved pressure balance. Additionally, the infrared heater assembly 234 may be configured for installation in a wider variety of systems, configurations and/or implementations with may increase flexibility of installation, maintenance, and/or replacement. Further, the lightweight design of the infrared heater assembly 234 enables decreased mounting components (e.g., fewer fasteners, fewer support structure components) compared to other heater configurations. As will be appreciated, a technician or installer may more easily couple or decouple the infrared heater assembly 234 at a desired installation location due to the lightweight construction of the infrared heater assembly 234 and reduced mounting components. Indeed, other heater configurations (e.g., gas heaters) may have a greater weight and/or size which may render manual installation by a single installer and/or a human installer unfeasible and/or unduly cumbersome.

As illustrated in FIG. 3, the infrared heater assembly 234 includes one or more infrared emitters 236 (e.g., infrared tubes, ultraviolet [UV] short wave tubes) extending across the air flow path 250 and configured to heat the air flow 254 directed along the air flow path 250 through the frame 249. Benefits of infrared emitters 236, compared to other heaters (e.g., UV heaters, gas heaters), include relatively quicker heating of heater components, longer operating life (e.g., 2 or more years), and reduced weight (e.g., up to 90 percent lighter). The infrared emitters 236 may extend between the first panel 258 and the second panel 262, such as along the X-axis 246 (e.g., a direction crosswise or substantially perpendicular to the direction of the air flow 254 along the air flow path 250). Additionally or alternatively, the infrared emitters 236 may extend from the first panel 258 to the second panel 262 along the X-axis 246. In some embodiments, the infrared emitters 236 may extend between the third panel 266 and the fourth panel 270, such as along the Y-axis 247 (e.g., vertical axis, a direction crosswise to the direction of the air flow 254 along the air flow path 250). Additionally or alternatively, the infrared emitters 236 may extend from the third panel 266 to the fourth panel 270 along the Y-axis 247. In some embodiments, some infrared emitters 236 may extend between the first panel 258 and the second panel 262 and other infrared emitters 236 may extend between the third panel 266 and the fourth panel 270. For example, a first set of infrared emitters 236 may extend between the first panel 258 and the second panel 262 (e.g., in a direction along the X-axis 246) and a second set of infrared emitters 236 may extend between the third panel 266 and the fourth panel 270 (e.g., in a direction along the Y-axis 247). In such embodiments, the infrared emitters 236 may be staggered or offset from one another, relative to the Z-axis 248.

The number of infrared emitters 236 incorporated in the infrared heater assembly 234 may be based on one or more dimensions of the frame 249, one or more operating parameters of the AHU 202, an expected heating demand, another suitable parameter, or any combination thereof. In some embodiments, dimensions of the frame 249 may be at least partially based on a parameter of the air flow 254 (e.g., flow rate, desired temperature). For example, relatively larger ducts and/or AHUs 202 (e.g., ducts and/or AHUs 202 including a relatively larger cross-sectional area, compared to smaller ducts and/or AHUs) may include an embodiment of the infrared heater assembly 234 having a relatively greater number of infrared emitters 236.

The infrared emitters 236 may be secured to the frame 249 and within the air flow path 250 via any suitable technique. For example, the infrared emitters 236 may be coupled to respective interior walls of the frame 249. In the embodiments illustrated in FIGS. 3 and 4, the infrared emitters 236 are coupled to a first interior wall 291 of the first panel 258 and a second interior wall 292 of the second panel 262. Specifically, the infrared emitters 236 are secured to the first interior wall 291 of the first panel 258 and the second interior wall 292 of the second panel 262 via mounting brackets 294 (e.g., via respective mounting brackets 294 coupled to the first interior wall 291 and the second interior wall 292). Each infrared emitter 236 may be secured to the frame 249 via two mounting brackets 294 (e.g., coupled to the first interior wall 291 of the first panel 258 and the second interior wall 292 of the second panel 262), in some embodiments. The mounting brackets 294 (e.g., brackets) are configured to support and retain the infrared emitters 236 to the frame 249 and within the air flow path 250 in a desired orientation.

In some embodiments, one or more of the mounting brackets 294 may include a shaped piece (e.g., L-shaped configuration, L-shaped bracket, L-shaped mounting bracket), which may include a first portion 295 and a second portion 296 extending crosswise to one another. The first portion 295 of the mounting bracket 294 may be configured to couple to the first interior wall 291 and/or the second interior wall 292 of a respective portion of the frame 249 (e.g., first panel 258, second panel 262) via any suitable technique, such as a welded bond. The second portion 296 may extend from the first portion 295, such as into the air flow path 250.

In some embodiments, the infrared heater assembly 234 (e.g., mounting bracket 294, such as the second portion 296) may include additional and/or alternative components configured to secure (e.g., receive and capture) the infrared emitters 236. For example, the infrared heater assembly 234 may include one or more (e.g., a plurality of) flexible mounting clips 298 (e.g., infrared emitter clips, mounting clips, flexible clips). In the illustrated embodiment, flexible mounting clips 298 are coupled (e.g., attached, secured) to the second portions 296 of the mounting brackets 294. One flexible mounting clip 298 is configured to secure a first end 299 of the infrared emitter 236 to one mounting bracket 294 (e.g., secured to the first interior wall 291 of the first panel 258), and another flexible mounting clip 298 is configured to secure a second end 301 of the infrared emitter 236 to another mounting bracket 294 (e.g., second interior wall 292 of the second panel 262). In some embodiments, one or more components of the infrared heater assembly 234 (e.g., one or more mounting brackets 294, one or more flexible mounting clips 298) may be formed from a heat-resistant material, such as stainless steel. In an embodiment, the flexible mounting clips 298 may electrically couple the infrared emitters 236 to the power source 239. The flexible mounting clips 298 may also have two or more prongs (e.g., fingers) formed from a flexible material that enable the flexible mounting clips 298 to deform, receive, capture, and retain the infrared emitter 236 (e.g., first end 299, second end 301) in a desired location, position, and/or orientation within the frame 249 and/or air flow path 250.

In an embodiment, the mounting brackets 294 and/or the flexible mounting clips 298 may be configured to secure the infrared emitters 236 in a desired location or position relative to (e.g., between) the first fin assembly 274 and the second fin assembly 278. For example, the mounting brackets 294 and/or the flexible mounting clips 298 may be implemented to retain the infrared emitters 236 in a centered location or position (e.g., along the Z-axis 248) between the first fin assembly 274 and the second fin assembly 278. However, in some embodiments, the infrared emitters 236 may be implemented in a non-uniform, offset, and/or staggered orientation relative to the first fin assembly 274 and the second fin assembly 278. For example, in some embodiments, one or more of the infrared emitters 236 may be positioned closer to the first fin assembly 274 and further from the second fin assembly 278. In another embodiment, one or more of the infrared emitters 236 may be positioned closer to the second fin assembly 278 and further from the first fin assembly 274.

The infrared emitters 236 may include any suitable type (e.g., a tube), configuration, and/or internal composition. As discussed above, the infrared emitters 236 may be configured to receive an electrical current, such as from the power source 239 (e.g., an offboard or disconnected power source) and may convert the electrical current into heat (e.g., electromagnetic radiation, infrared wavelengths). For example, the infrared emitters 236 may include a halogen short wave tube, carbon infrared tube, quartz infrared tube, metallic infrared tube, ceramic infrared tube, reflector infrared tube, flexible infrared tube, any other suitable tube, or a combination thereof. Further, the size of the infrared emitters 236 may be based on dimensions (e.g., a perimeter, heigh, width) of the frame 249, such as a distance between the first panel 258 and the second panel 262 and/or a dimension (e.g., length, width) of the first panel 258, the second panel 262, the third panel 266, and/or the fourth panel 270. As will be appreciated, the infrared emitters 236 disclosed herein may include any voltage or current ratings, any heat output, any tube diameter, and/or any material of construction. Indeed, some of the infrared emitters 236 operating parameters (e.g., power output, voltage rating, current rating), dimensions, type, configuration, and/or other parameters may depend on other parameters and/or components of the HVAC&R system (e.g., the power source 239, the controller 230, components thereof), such as the capacity of the AHU 202, an air flow rate, expected temperature and/or temperature ranges of the supply air flow, and so forth.

As discussed briefly above, the infrared heater assembly 234 may include the first fin assembly 274 and the second fin assembly 278. Each of the first fin assembly 274 and the second fin assembly 278 may include one or more heat transfer components configured to receive (e.g., capture from the infrared emitters 236), retain, and/or radiate energy. In some embodiments, the first fin assembly 274 and the second fin assembly 278 may each include a plurality of fins. For example, the first fin assembly 274 may include a first plurality of fins 302, and the second fin assembly 278 may include a second plurality of fins 303. The one or more heat transfer components (e.g., fins 302, 303) may receive infrared light and/or retain thermal radiation emitted by the infrared emitters 236 and may subsequently radiate heat to the air flow 254 as the air flow 254 is directed through and/or across the first fin assembly 274 and the second fin assembly 278 (e.g., between the first plurality of fins 302, between the second plurality of fins 303).

In an embodiment, the first plurality of fins 302 of the first fin assembly 274 and/or the second plurality of fins 303 of the second fin assembly 278 may extend across the air flow path 250 and may be configured to enable flow of the air flow 254 therethrough. For example, the first plurality of fins 302 may be arrayed in a first spaced arrangement (e.g., along the X-axis 246) to enable flow of the air flow 254 therethrough, and the second plurality of fins 303 may be arrayed in a second spaced arrangement (e.g., along the X-axis 246) to enable flow of the air flow 254 therethrough. In the illustrated embodiments of FIGS. 3 and 4, each fin 302 of the first plurality of fins 302 extends between the third panel 266 and the fourth panel 270 along the Y-axis 247, and each fin 303 of the second plurality of fins 303 extends between the third panel 266 and the fourth panel 270 along the Y-axis 247. However, in other embodiments, one or more fins 302 of the first plurality of fins 302 and/or one or more fins 303 of the second plurality of fins 303 may extend between the first panel 258 and the second panel 262, such as along the X-axis 246. Indeed, an orientation of the first plurality of fins 302 and/or an orientation of the second plurality of fins 302 may depend on an orientation of the infrared emitters 236 and/or on another suitable parameter (e.g., parameter of the air flow 254).

For example, in embodiments employing laterally-extending infrared emitters 236 (e.g., extending along the X-axis 246), such as those illustrated in FIG. 3, the first plurality of fins 302 and the second plurality of fins 303 may extend along the Y-axis 247. In this way, the first plurality of fins 302 and the second plurality of fins 303 may heat the air flow 254 in a more uniform manner, such as compared to heaters that do not implement fins or louvers and/or implement a single orientation of heating elements. In any case, as the air flow 254 enters the infrared heater assembly 234 (e.g., frame 249, air flow inlet 275, first fin assembly 274), the first plurality of fins 302 of the first fin assembly 274 may distribute the air flow 254 to the infrared emitters 236 disposed downstream of the first fin assembly 274, relative a direction of the air flow 254. The infrared emitters 236 may heat the air flow 254 via infrared heat to a desirable temperature, and the air flow 254 may exit the infrared heater assembly 234 via the air flow outlet 277 (e.g., second fin assembly 278).

As will be appreciated, the infrared emitters 236 may also heat (e.g., via electromagnetic radiation) the first plurality of fins 302 of the first fin assembly 274 and the second plurality of fins 303 of the second fin assembly 278. Indeed, the infrared emitters 236 may operate to rapidly heat the first plurality of fins 302 and the second plurality of fins 303. The first plurality of fins 302 and the second plurality of fins 303 may absorb and/or retain the heat and may transfer the heat to the air flow 254 as the air flow 254 is directed through the first fin assembly 274 and the second fin assembly 278, respectively. In this way, heating of the air flow 254 may be improved and may be achieved with greater efficiency. That is, the infrared emitters 236 may enable heating of the air flow 254 directly, as well as indirectly via the first fin assembly 274 and the second fin assembly 278. The infrared emitters 236, the first fin assembly 274, and the second fin assembly 278 may enable more uniform heating of if the air flow 254, which may result in further increased uniformity of heated air flow downstream (e.g., discharged air flow) of the infrared heater assembly 234 and more efficient operation of the infrared heater assembly 234.

The first plurality of fins 302 and/or the second plurality of fins 303 may include any suitable configuration, orientation, shape, and/or spacing, which may depend on one or more parameters (e.g., a dimension) of the frame 249 and/or one or more parameters of the HVAC&R system 100 and/or the AHU 202. In some embodiments, one or more fins 302 of the first plurality of fins 302 and/or one or more fins 303 of the first plurality of fins 303 may be corrugated (e.g., wavy or zig-zagged shape) and/or may include one or more holes (e.g., apertures) at various locations along the respective length of the fin 302 and/or fin 303. The corrugated configuration of the one or more fins 302 and/or fins 303 and/or the one or more holes may be configured to increase a flow rate of the air flow 254 through the infrared heater assembly 234, which may enhance convective heat transfer, enhance flow of the air flow 254, and/or reduce flow resistance, such as compared to flat or relatively uninterrupted fins (e.g., straight, non-corrugated fins). Spacings between respective fins 302 of the first plurality of fins 302 and/or spacing between respective fins 303 of the second plurality of fins 303 may be determined or selected based on relevant factors or parameters, such as a flow rate of the air flow 254, a type and/or number of the infrared emitters 236, a size of the frame 249, one or more parameters of the HVAC&R system 100 (e.g., AHU 202), and so forth. Suitable shapes include, but are not limited to, rectangular fins, triangular fins, parabolic fins, tapered fins, and so forth. Further, the material of the first plurality of fins 302 and/or the second plurality of fins 303 may include any suitable material, including aluminum, copper, or another suitable material.

In an embodiment, the first fin assembly 274 and/or the second fin assembly 278 may include one or more support beams (e.g., support rods) configured to support or secure the first plurality of fins 302 and/or the second plurality of fins 303, respectively, within or to the frame 249. For example, the first fin assembly 274 may include one or more first support beams 306 extending crosswise (e.g., along the X-axis 246) to a length of the first plurality of fins 302 (e.g., a dimension of the fins 302 between the third panel 266 and the fourth panel 270). Similarly, the second fin assembly 278 may include one or more second support beams 307 extending crosswise (e.g., along the X-axis 246) to a length of the second plurality of fins 303. The one or more first support beams 306 may be positioned at varying locations along the height (e.g., along the Y-axis 247) of the first fin assembly 274, and/or the one or more second support beams 307 may be positioned at varying locations along the height (e.g., along the Y-axis 247) of the second fin assembly 278. Each fin 302 of the first plurality of fins 302 may be coupled (e.g., secured) to one or more of the first support beams 306, and each fin 303 of the second plurality of fins 303 may be coupled (e.g., secured) to one or more of the second support beams 307.

Referring particularly to FIG. 4, a cross-sectional plan view of an embodiment of the infrared heater assembly 234 is shown, in accordance with aspects of the present disclosure. As discussed above, the infrared heater assembly 234 may include the first panel 258 and the second panel 262 at least partially defining the frame 249 configured to direct the air flow 254 therethrough. Discussed above, the infrared heater assembly 234 may include the first fin assembly 274 (e.g., upstream fin assembly) configured to receive the air flow 254 via the air flow inlet 275 and the second fin assembly 278 (e.g., downstream fin assembly) configured to discharge the air flow 254 via the air flow outlet 277. As mentioned above, the first fin assembly 274 may include the first plurality of fins 302 and/or the second fin assembly 278 may include the second plurality of fins 303 configured to transfer heat to the air flow 254. Respective fins 302, 303 (e.g., adjacent fins) of the first plurality of fins 302 and the second plurality of fins 303 may be spaced apart from one another at a suitable distance to enable the air flow 254 to pass through the infrared heater assembly 234, while also enabling heating of the air flow 254 by the fins 302, 303. In some embodiments, a type (e.g., straight, corrugated) and/or orientation (e.g., laterally oriented, vertically oriented, fin spacing, etc.) of the fins 302 of the first fun assembly 274 may be the same as the type and/or orientation of the fins 303 of the second fin assembly 278. In some embodiments, the type and/or orientation of fins 302 of the first fin assembly 274 may be different than the type and/or orientation of the fins 303 of the second fin assembly 278. In an embodiment, the second plurality of fins 303 of the second fin assembly 278 may be angled with respect to the a direction of the air flow 254 into the frame 249. In this way, the air flow 254 leaving or discharged from the infrared heater assembly 234 may be forced in a desired direction, for example, to facilitate direction of air in an angled or curved duct and/or AHU 202.

The fins 302 and/or fins 303 may include any material suitable to structurally withstand a pressurized air flow (e.g., air flow 254) while enabling heat absorption from the infrared emitters 236 and heat transfer to the air flow 254. Further, the fins 302 and/or fins 303 may include any shape desirable, such as corrugated fins, perforated fins, serrated fins, and/or herringbone fins. The fins 302 and/or fins 303 may be constructed from any suitable material, such as stainless steel (e.g., 16-gauge stainless steel). Each fin 302 of the first plurality of fins 302 and/or each fin 303 of the second plurality of fins 303 may include any suitable width 308 (e.g., a dimension along the X-axis 248), which may be consistent (e.g., the same for every fin 302 of the first plurality of fins 302 and/or the same for every fin 303 of the second plurality of fins 303) or non-uniform across the plurality of fins 302, 303. For example, the width 308 of the fins 302 and/or fins 303 may be one in which the fins 302 and/or fins 303 are disposed within the frame 249 and are positioned a desirable distance away from the infrared emitters 236, thereby enabling increased absorption of heat by the fins 302 and/or fins 303 from the infrared emitters 236. Indeed, the fins 302 may heat the air flow 254 before the air flow 254 is directed across the infrared emitters 236, and the fins 303 may heat the air flow 254 after the air flow 254 is directed across the infrared emitters 236.

FIG. 5 is an exploded perspective view schematic of an embodiment of the infrared heater assembly 234 disposed within a housing 310 (e.g., duct, supply air duct 212) of an embodiment of the AHU 202, in accordance with the present disclosure. The housing 310 may include an air inlet 314 configured to receive return air and/or outside air and a supply air outlet 318 configured to direct supply air to a conditioned space. In some embodiments, the housing 310 may include a mounting wall 286 (e.g., heater mounting wall) disposed within the housing 310 and configured to enable mounting of the infrared heater assembly 234 in an installed configuration within the housing 310. The mounting wall 286 may extend into an air flow path 309 defined by the housing 310 and may include an aperture 322 (e.g., opening, mounting aperture) configured to enable the air flow 254 to pass therethrough. The aperture 322 may be oriented in a generally centralized location (e.g., vertically centered within the AHU 202, relative to Y-axis 247; horizontally centered within the AHU 202, relative to X-axis 246) of the mounting wall 286, such as to receive the air flow 254 along the air flow path 309. A generally centralized location of the aperture 322, relative to the housing 310 and/or the air flow path 309, may improve air flow through the housing 310, such as by reducing stagnant air near sides of the housing 310 and/or at intersections between the sides of the housing 310 and the mounting wall 286.

As discussed above, the mounting wall 286 may include one or more holes 326 (e.g., mounting holes) configured to align with the one or more holes 290 of the infrared heater assembly 234. The aligned holes 326 of the mounting wall 286 and the holes 290 of the infrared heater assembly 234 (e.g., frame 249, flanges 282) may receive one or more fasteners to enable mounting of the infrared heater assembly 234 to the mounting wall 286 (e.g., within the aperture 322, adjacent the aperture 322). In an installed configuration, the aperture 322 may be aligned with the air flow path 250 through the frame 249, relative to a direction of the air flow 254 through the frame 249 and/or the AHU 200 (e.g., housing 310). As will be appreciated, the lightweight design of the infrared heater assembly 234, compared to other heater configurations, may enable a wall-mounted installation configuration of the infrared heater assembly 234, such as in a generally centralized position within the housing 310 (e.g., not resting on a base 324 or floor surface of the housing 310). In other words, the infrared heater assembly 234 may be mounted to the mounting wall 286, such that the infrared heater assembly 234 is suspended within the air flow path 309 above the base 324 of the housing 310. In this way, a flow rate of the air flow 254 through the infrared heater assembly 234 within and/or adjacent to the aperture 322 may be increased. Additionally, the centralized position of the infrared heater assembly 234 within the housing 310 may enable increased heating uniformity, opposed to a floor resting or mounted heater. Moreover, the lightweight design of the infrared heater assembly 234 may facilitate manufacturing (e.g., enabling assembly line-type manufacturing), which may reduce manufacturing costs.

Sizes (e.g., dimensions) of the housing 310, the aperture 322 within the mounting wall 286, and/or the mounting wall 286 may be based on building dimensions and/or parameters of the air flow 254 (e.g., flow rate). Further, as discussed above, the size (e.g., physical dimensions) of the infrared heater assembly 234 may be based on dimensions of the aperture 322 within the mounting wall 286. As such, one or more dimensions or parameters of the infrared heater assembly 234 may be at least partially based on a parameter of the air flow 254 directed through the housing 310. However, in some instances, the reduced size of the infrared heater assemblies 234 may enable reduced duct sizing and/or a reduced overall size of the AHU 202. Although one infrared heater assembly 234 and one mounting wall 286 are illustrated, it will be appreciated that more than one (e.g. 2, 3, 4) infrared heater assembly 234 and/or mounting wall 286 may be used within the housing 310 of the HVAC&R system 100 and/or the AHU 202. For instance, the housing 310 may include a first mounting wall 286 having a first infrared heater assembly 234, a second mounting wall 286 positioned downstream of the first mounting wall 286, and having a second infrared heater assembly 234, and so forth. Multiple infrared heater assemblies 234 may increase the heating capabilities of the AHU 202, which may allow for faster heating of a desired conditioning space.

Embodiments of the present disclosure are directed to an improved heater assembly configured to thermally regulate an air flow, such as an air flow directed through an air handling unit (AHU). For instance, an infrared heater assembly having on or more infrared emitters (e.g., infrared tubes) may be positioned within a housing, such as on a mounting wall, and configured to heat the air flow directed through an aperture of the mounting wall. The infrared heater assembly may include frame defined by a first panel, a second panel, a third panel, and a fourth panel, and may be configured to couple to (e.g., encase) the one or more infrared emitters. The infrared heater assembly may also include a first fin assembly and a second fin assembly, where the first fin assembly may receive the air flow via an air flow inlet of the frame, and the second fin assembly may discharge or disperse the air flow via an air flow outlet of the frame. The first fin assembly side, the second fin assembly, or both may include a plurality of heat transfer components, such as fins or louvers, configured to receive and retain heat or infrared light emitted from the infrared emitters and subsequently radiate heat to the air flow, thereby heating the air flow. The arrangement of the plurality of fins relative to the one or more infrared emitters may heat the air flow with increased uniformity, compared to other heaters. Compared to other heaters and heating systems, the infrared heater assemblies described herein may include a comparatively lighter weight. As such, the lightweight design of the infrared heater assembly may enable a wall mounted installation configuration of the infrared heater assembly, such as in a centralized position within the housing (e.g., not resting on a base or floor surface of the housing). The centralized position of the infrared heater assembly within the duct may enable increased heating uniformity and reduced flow resistance, opposed to a floor resting or mounted heater. Moreover, the lightweight design of the infrared heater assembly may facilitate manufacturing (e.g., enabling assembly line-type manufacturing), which may reduce manufacturing costs, as well as improved installation, maintenance, removal, and/or replacement.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heater assembly for a heating, ventilation, air conditioning, and refrigeration (HVAC&R) system, wherein the heater comprises:
a frame comprising a first panel, a second panel, a third panel, and a fourth panel cooperatively defining an air flow inlet, an air flow outlet, and an air flow path extending through the frame from the air flow inlet to the air flow outlet;
a first fin assembly disposed within the frame at the air flow inlet;
a second fin assembly disposed within the frame at the air flow outlet; and
a plurality of infrared emitters disposed within the frame, extending across the air flow path, and extending between the first panel and the second panel, wherein the plurality of infrared emitters is configured to heat an air flow directed through the frame and along the air flow path, and wherein the plurality of infrared emitters is configured to heat the first fin assembly, the second fin assembly, or both.

2. The heater assembly of claim 1, wherein the first fin assembly comprises a first plurality of fins extending across the air flow path and between the third panel and the fourth panel, the second fin assembly comprises a second plurality of fins extending across the air flow path and between the third panel and the fourth panel, and the first plurality of fins and the second plurality of fins extend crosswise to a respective length of each infrared emitter of the plurality of infrared emitters.

3. The heater assembly of claim 2, wherein the first fin assembly comprises a first support beam extending across the air flow path and between the first panel and the second panel, each fin of the first plurality of fins is coupled to the first support beam, the second fin assembly comprises a second support beam extending across the air flow path and between the first panel and the second panel, and each fin of the second plurality of fins is coupled to the second support beam.

4. The heater assembly of claim 2, wherein the plurality of infrared emitters is disposed between the first fin assembly and the second fin assembly, relative to a direction of the air flow through the frame and along the air flow path, and each infrared emitter of the plurality of infrared emitters is configured to emit electromagnetic radiation to heat the first plurality of fins and the second plurality of fins.

5. The heater assembly of claim 4, wherein the first plurality of fins is arrayed in a first spaced arrangement to enable flow of the air flow therethrough, the first plurality of fins is configured to heat the air flow received via the air flow inlet, upstream of the plurality of infrared emitters relative to the direction of the air flow through the frame and along the air flow path, the second plurality of fins is arrayed in a second spaced arrangement to enable flow of the air flow therethrough, and the second plurality of fins is configured to heat the air flow discharged from the frame via the air flow outlet, downstream of the plurality of infrared emitters relative to the direction of the air flow through the frame and along the air flow path.

6. The heater assembly of claim 1, wherein the frame comprises a plurality of flanges extending outward, relative to the air flow path, from the first panel, the second panel, the third panel, the fourth panel, or any combination thereof, and the plurality of flanges comprises a plurality of holes formed therethrough and configured to receive corresponding fasteners to couple the heater assembly to a heater mounting wall of the HVAC&R system.

7. The heater assembly of claim 1, comprising a plurality of mounting brackets configured to secure the plurality of infrared emitters to the frame and within the air flow path, wherein each mounting bracket of the plurality of mounting brackets is attached to the first panel or the second panel.

8. The heater assembly of claim 7, wherein each infrared emitter of the plurality of infrared emitters is coupled to the first panel via a respective first mounting bracket of the plurality of mounting brackets, and each infrared emitter of the plurality of infrared emitters is coupled to the second panel via a respective second mounting bracket of the plurality of mounting brackets.

9. The heater assembly of claim 8, wherein each mounting bracket of the plurality of mounting brackets is an L-shaped bracket.

10. The heater assembly of claim 7, comprising a plurality of flexible mounting clips, wherein each flexible mounting clip of the plurality of flexible mounting clips is coupled to a corresponding mounting bracket of the plurality of mounting brackets, and each flexible mounting clip of the plurality of flexible mounting clips is configured to receive and capture a corresponding end of an infrared emitter of the plurality of infrared emitters.

11. A heating, ventilation, air conditioning, and refrigeration (HVAC&R) system, comprising:
an air handling unit comprising a housing configured to receive and direct an air flow therethrough;
a mounting wall disposed within the housing of the air handling unit, wherein the mounting wall comprises an aperture;
an infrared heater assembly mounted to the mounting wall, wherein the infrared heater assembly comprises:
a frame defining an air flow path extending through the frame and configured to direct the air flow through the frame, wherein the air flow path is aligned with the aperture of the mounting wall relative to a direction of the air flow through the housing; and
a plurality of infrared emitters coupled to the frame and disposed within the air flow path, wherein the plurality of infrared emitters is configured to heat the air flow directed through the frame; and
a controller communicatively coupled to the plurality of infrared emitters and configured to operate the plurality of infrared emitters to heat the air flow, wherein the controller is physically separate from the infrared heater assembly.

12. The HVAC&R system of claim 11, wherein the infrared heater assembly is mounted to the mounting wall, such that the infrared heat assembly is suspended within the housing of the air handling unit above a base panel of the housing.

13. The HVAC&R system of claim 11, wherein the infrared heater assembly comprises:
a first fin assembly coupled to the frame and disposed upstream of the plurality of infrared emitters, relative to the direction of the air flow through the housing, wherein the first fin assembly comprises a first plurality of fins; and
a second fin assembly coupled to the frame and disposed downstream of the plurality of infrared emitters, relative to the direction of the air flow through the housing, wherein the second fin assembly comprises a second plurality of fins,
wherein the plurality of infrared emitters is configured to heat the first plurality of fins and the second plurality of fins.

14. The HVAC&R system of claim 13, wherein each infrared emitter of the plurality of infrared emitters extends along a first direction between a first panel of the frame and a second panel of the frame, each fin of the first plurality of fins extends along a second direction, crosswise to the first direction, between a third panel of the frame and a fourth panel of the frame, and each fin of the second plurality of fins extends along the second direction between the third panel of the frame and the fourth panel of the frame.

15. The HVAC&R system of claim 11, wherein the frame comprises a plurality of flanges extending outward relative to the air flow path defined by the frame, the plurality of flanges comprises a plurality of holes formed therethrough, and the infrared heater assembly is secured to the mounting wall via a plurality of fasteners extending through the plurality of holes and into the mounting wall.

16. The HVAC&R system of claim 11, comprising a plurality of L-shaped brackets secured to interior walls of the frame, wherein the plurality of infrared emitters is coupled to the frame via the plurality of L-shaped brackets.

17. The HVAC&R system of claim 16, comprising a plurality of flexible mounting clips, wherein each flexible mounting clip of the plurality of flexible mounting clips is coupled to a corresponding L-shaped bracket of the plurality of L-shaped brackets, and each flexible mounting clip of the plurality of flexible mounting clips is configured to capture a corresponding end of an infrared emitter of the plurality of infrared emitters.

18. An infrared heater assembly, comprising:
a frame comprising a plurality of panels coupled to one another, wherein the plurality of panels defines an air flow path extending through the frame from an air flow inlet of the frame to an air flow outlet of the frame;
a first fin assembly coupled to the frame and disposed within the air flow path, wherein the first fin assembly comprises a first plurality of fins;
a second fin assembly coupled to the frame and disposed within the air flow path, wherein the second fin assembly comprises a second plurality of fins; and
a plurality of infrared emitters coupled to the frame and positioned between the first fin assembly and the second fin assembly, relative to a direction of an air flow through the frame and along the air flow path, wherein the plurality of infrared emitters is configured to heat the air flow, the first plurality of fins, and the second plurality of fins.

19. The infrared heater assembly of claim 18, wherein at least one infrared emitter of the plurality of infrared emitters comprises a halogen short wave tube, a carbon infrared tube, a quartz infrared tube, a metallic infrared tube, a ceramic infrared tube, a reflector infrared tube, or a flexible infrared tube.

20. The infrared heater assembly of claim 18, wherein each infrared emitter of the plurality of infrared emitters extends with the frame and across the air flow path along a first direction, each fin of the first plurality of fins extends with the frame and across the air flow path along a second direction, crosswise to the first direction, and each fin of the second plurality of fins extends with the frame and across the air flow path along the second direction.
